(19) United States
(12) Patent Application Publication
(10) Pub. No.: US 2022/0132877 A1
(43) Pub. Date: May 5, 2022

(54) Methods of Making a Treated Fruit Composition

(71) Applicant: General Mills, Inc., Minneapolis, MN (US)

(72) Inventor: Jie Sun, Plymouth, MN (US)

(73) Assignee: General Mills, Inc., Minneapolis, MN (US)

(21) Appl. No.: 17/435,243

(22) PCT Filed: Apr. 3, 2019
(86) PCT No.: PCT/US2019/025619

§ 371 Date: Aug. 31, 2021

(51) Int. Cl. A23B 7/144; A23B 7/155; A23B 7/157; A23B 7/08; A23B 7/005; A23B 7/04; A23L 29/231; A23L 29/212; A23L 19/00

(52) U.S. Cl. CPC A23B 7/144; A23B 7/155; A23B 7/157; A23B 7/08; A23V 2002/00; A23B 7/04; A23L 29/231; A23L 29/212; A23L 19/03; A23B 7/005

(57) ABSTRACT

A method is described for making a treated fruit having improved flavor, texture, and/or yield over thermally pasteurized fruit. The method includes providing a packaged premix that includes fruit with pectin methylesterase, calcium, and sugar, tempering the premix to produce tempered fruit, then treating the tempered fruit with high pressure pasteurization.

### BACKGROUND

Fresh fruit is a food enjoyed by many different cultures. Fruit used in shelf-stable applications, fresh dairy, or dairy-free alternative products is generally pasteurized using heat treatment to ensure the microbial stability of the fruit. However, heat from elevated temperature pasteurization affects flavor and texture of fruits, and can result in fewer intact pieces after high temperature pasteurization, reducing the effective yield.

### SUMMARY

The present disclosure relates to methods of making a treated fruit composition.

Provided herein is a method of making a treated fruit. A method includes providing a premix in a container at a temperature at or below 70° F., producing tempered fruit by tempering the premix at a temperature of about 110° F. to about 160° F. for 20-60 minutes, adjusting the temperature of the tempered fruit to a temperature of 32-70° F., and subjecting the cooled tempered fruit to high pressure pasteurization (HPP) to produce the treated fruit. A premix used in a method provided herein includes about 10% to about 98% fruit by weight, 0.009% to about 0.05% pectin methylesterase (PME) by weight of the fruit, 0.009% to about 0.1% calcium salt by weight of the fruit, about 1% to about 45% sugar by weight, and up to about 88% water by weight;

In some embodiments, a method can further include producing the premix by providing a frozen fruit composition, the frozen fruit composition including individually frozen fruit, mixing the frozen fruit composition with water or an aqueous solution and dry ingredients to produce the premix, and placing the premix in the container.

In some embodiments a frozen fruit composition can include PME and/or calcium.

In some embodiments, an aqueous solution can include PME and/or calcium.

In some embodiments, dry ingredients can include PME and/or calcium.

In some embodiments, a method can further include producing a frozen fruit composition by providing individually frozen fruit, applying a solution of PME to the surface of the individually frozen fruit, and applying a solution including calcium to the surface of the individually frozen fruit. In some embodiments, PME and calcium can be in a single solution. In some embodiments, PME can be applied at a rate of about 0.01% to about 0.03% by weight enzyme based on the weight of the individually frozen fruit. In some embodiments, calcium can be applied at a rate of about 0.01% to about 0.06% calcium salt by weight based on the weight of the individually frozen fruit.

In some embodiments of a method provided herein, the premix further can include starch or pectin.

In some embodiments of a method provided herein, the premix further can include about 0.05% to about 2% pectin.

In some embodiments of a method provided herein, the premix further can include about 1% to about 5% pregelatinized starch.

In some embodiments of a method provided herein, the premix can be tempered at 130-140° F. for 40-60 minutes.

In some embodiments of a method provided herein, HPP can be performed at 80,000 psi to about 90,000 psi for 60 seconds to 180 seconds. In some embodiments, HPP can be performed at about 86,000 psi for about 120 seconds.

In some embodiments of a method provided herein, tempered fruit can be stored in refrigerated or frozen conditions prior to adjusting the temperature of the tempered fruit to 32-70° F.

These and various other features and advantages will be apparent from a reading of the following detailed description.

### DRAWINGS

FIG. 1 is a graph showing firmness of strawberry cubes treated according to Example 1.

FIG. 2 is a picture of thermally pasteurized fruit (left) and high pressure pasteurized fruit treated according to a method described herein (right).

### DETAILED DESCRIPTION

Fruit is challenging to preserve because many treatments that reduce microbial load and/or microbial activity can result in tissue damage of the fruit and/or activation of enzymes in the fruit that can modify the texture of the fruit.

As disclosed herein, it has been discovered that a treatment of a premix that contains fruit with a tempering step prior to high pressure pasteurization (HPP) results in a treated fruit having improved texture, yield, and fresh-like flavor over pasteurization using heat treatment. Surprisingly, a tempering step prior to HPP results in less browning and a better texture as compared to the use of HPP without a tempering step as described herein. Also surprising is that the present method can be used with both fresh and frozen fruit to achieve a high quality treated fruit.

As used herein, the term “fruit” refers to fruits and edible plant parts. Fruits include, for example, strawberries, blackberries, blueberries, currants, raspberries, cranberries, other fruits from shrubs or bushes, peaches, apricots, plums, cucumbers, coconuts, pears, leafy greens (e.g., lettuce, spinach, and the like), leafy herbs (e.g., basil, mint, and the like), and the like. As used herein, the term fruit refers to whole fruits or solid pieces of fruit, and not a fruit juice or mash.

A premix suitable for use in a method of making a treated fruit provided herein contains fruit, pectin methylesterase (PME), calcium, and sugar. Fruit in a premix is included in an amount of from about 10% to about 98% (e.g., about 40% to about 95%, or about 50% to about 80%) by weight of the premix.

Pectin methylesterase is included in a premix in an amount of about 0.009% to about 0.05% (e.g., about 0.01% to about 0.03%) by weight, based on the weight of the fruit included in the premix. That is, if fruit is included in an amount of 90% by weight of the premix, PME can be included in an amount of about 0.008% to about 0.045% by weight of the premix.

Calcium is included in a premix in an amount based on the form of the calcium used. Generally, the amount of calcium included in an amount sufficient for reactivity of PME with pectin (either in the fruit or added pectin) in the premix. In some embodiments, a calcium salt (e.g., CaCl₂, calcium citrate, tricalcium phosphate, and the like) can be included in a premix in an amount of about 0.002 moles to about 0.018 moles per gram of PME in the premix. In some embodiments, a calcium salt can be included in a premix at a ratio 1:1 to 2:1 by weight of calcium salt to PME. For example, CaCl2 can be included in an amount of about 0.009% to about 0.1% by weight, based on the weight of the fruit included in the premix.

Sugar is included in a premix in an amount of about 1% to about 45% (e.g., about 10% to about 40%, or about 15% to about 25%) by weight of the premix. Suitable sugars include sucrose, fructose, honey, and the like. Preferably, a sugar is in dry form (e.g., granulated sugar, powdered sugar, or the like).

In some embodiments, water can be included in a premix in an amount of up to about 88% (e.g., from about 8% to about 12%) by weight of the premix. Water can be included alone or as an aqueous solution (e.g., as a fruit juice, or a calcium solution). The amount of fruit and water in a premix can be adjusted based on the desired amount of liquid in the treated fruit. For example, no water or a low amount of water can be used if the treated fruit is desired to have little liquid.

In some embodiments, a premix can include starch in an amount of up to about 5% (e.g., about 1% to about 5%, or about 2% to about 4%) by weight of the premix. A suitable starch can be pregelatinized or can gelatinize at a temperature at or below 70° F.

In some embodiments, a premix can include pectin in an amount of up to about 2% (e.g., about 0.05% to about 2%, about 0.1% to about 0.3%, or about 0.15% to about 0.25%) by weight of the premix. In some embodiments, a pectin included in a premix provided herein is a low methoxyl pectin or other non-high methoxyl pectin.

Other suitable ingredients can be included in a premix, such as flavors (e.g., vanilla), colorants (e.g., fruit or vegetable extracts), non-caloric sweeteners (e.g., stevia extract), and the like.

A premix can be made using any suitable method. In some embodiments, fruit used to make a premix can be frozen, such as individually frozen (e.g., individually quick frozen, or IQF) fruit. As used herein, the term “frozen” refers to a fruit that is whole, cut, washed, or unwashed, and has been frozen to a temperature at or below 32° F.

If frozen fruit is used to make a premix, PME and/or calcium can be combined with the fruit prior to freezing or after freezing. In some embodiments, individually frozen (e.g., IQF) fruit can be sprayed or submerged with a solution containing about PME and/or calcium.

In some embodiments, PME and/or calcium can be included as a dry ingredient or as a solution that is mixed with fruit (e.g., frozen fruit). Preferably, PME and calcium are applied to frozen fruit (e.g., IQF fruit), then the remaining ingredients are mixed with the calcium and PME-treated frozen fruit. PME and calcium-treated frozen fruit can be stored frozen prior to combining with the remaining ingredients, or mixed directly with the remaining ingredients, or allowed to thaw before being mixed with the remaining ingredients to make a premix.

A premix provided herein is packaged in a container suitable for high pressure pasteurization (HPP). Any container suitable HPP can be used, including a pouch, a bag, or other flexible packaging. Preferably, a container suitable for use in a method provided herein is also suitable for tempering a premix, cooling tempered fruit, storage of tempered fruit (e.g., refrigerated or frozen storage), and storage of treated fruit (e.g., refrigerated or frozen storage). In some embodiments, once a premix is enclosed in a container, it remains in the same container in a method provided herein through production of a treated fruit. In some embodiments, once a premix is enclosed in a container, it remains in the same container in a method provided herein until the resulting treated fruit is ready for use by a consumer or in a food product.

A packaged premix is tempered to produce tempered fruit. A premix can be at a temperature at or below 70° F. (e.g., about 32° F. to about 50° F.) prior to tempering. Tempering includes bringing the premix to a temperature of from about 110° F. to about 160° F. (e.g., from about 120° F. to about 140° F., or about 125° F. to about 135° F.) and maintaining the temperature of the fruit within that range for about 20 minutes to about 60 minutes (e.g., about 40 minutes to about 60 minutes). Tempering can be performed using any appropriate equipment and method, such as submerging a premix in a container in a water bath or placing a premix in a container in a hot room, hot air blast tunnel, or oven.

It is to be understood that tempering at lower temperatures (e.g., about 110° F. to about 135° F.) can be done for longer periods of time (e.g., about 40 minutes to about 60 minutes) to achieve similar results as at higher temperatures (e.g., about 135° to about 160° F.) for shorter periods of time (e.g., about 20 minutes to about 45 minutes). Although the temperature of the fruit can vary during the tempering treatment, the total amount of time at 120-160° F. should be from 20-40 minutes.

A premix in a container can be brought to tempering temperature using any appropriate method and equipment. For example, in some embodiments, a premix in a container can be warmed to tempering temperature in the same equipment as is used for tempering. The amount of time that a premix in a container takes to be brought to tempering temperature can be determined using any appropriate method. In some embodiments, the amount of time a premix in a container needs to be warmed to reach tempering temperature can be calculated based on previous testing using temperature sensors placed throughout samples of the premix, with different volumes, starting temperatures, desired tempering temperatures, and the like. In some embodiments, different calculations can be made based on different premix formulations, container types, and the like.

Following tempering, tempered fruit is cooled to a temperature at or below 70° F. (e.g., e.g., about 50° F. or below, or about 32° F. to about 50° F.). In some embodiments, tempered fruit is cooled to a temperature suitable for HPP (e.g., about 32° F. to about 70° F., or about 32° F. to about 50° F.) and subjected to HPP to produce a treated fruit. Tempered fruit can be cooled using any suitable method or equipment. For example, in some embodiments, tempered fruit can be allowed to cool at room temperature or in a chilled room or cooler. In some embodiments, tempered fruit can be cooled in a water bath.

In some embodiments, tempered fruit can be cooled to a temperature at or below 40° F. (e.g., at or below 35° F., or at or below 32° F.) and stored refrigerated or frozen prior to subjecting the premix to HPP. If a premix is frozen prior to HPP, it can be adjusted to a temperature suitable for HPP prior to subjecting the premix to HPP.

HPP can be performed using any appropriate equipment and conditions that results in a treated fruit that is pasteurized. As used herein, a treated fruit is considered pasteurized if the treated fruit has a microbial load of less than 10 CFU per gram coliforms, less than 10 CFU per gram yeast, and less than 10 CFU per gram mold. Microbial load of a treated fruit can be determined using standard techniques. For example, coliform load can be determined using the US Food and Drug Administration Bacteriological Analytical Manual, Chapter 4 protocols, or other methods, such as the Petrifilm protocol (Entis, P. 1989. Hydrophobic grid membrane filter/MUG method for total coliform and Escherichia coli enumeration in foods: collaborative study. J. Assoc. Off. Anal. Chem. 72:936-950). In another example, the microbial load of yeasts and molds can be determined using the US Food and Drug Administration Bacteriological Analytical Manual, Chapter 18 protocols.

In some embodiments, HPP can be performed at a pressure of about 80,000 psi to about 90,000 psi for about 60 seconds to about 180 seconds. For example, HPP can be performed at about 86,000 psi for about 120 seconds. HPP conditions can be adjusted based on container type and formulation of a tempered fruit to be HPP treated. In some embodiments, HPP conditions can be tested for various formulations, volumes, starting temperatures, container types, and the like, to determine HPP conditions that result in treated fruit that is pasteurized for any given product design.

A treated fruit produced by a method provided herein can be used in any way that a thermally pasteurized fruit can be used. For example, a treated fruit can be used as a jam-like product on its own, or included in another food, such as a fresh dairy product (e.g., yogurt or cottage cheese), ice cream, or a non-dairy product (e.g., a non-dairy yogurt or non-dairy ice cream).

In some embodiments, a treated fruit provided herein can have a Bostwick viscosity of about 2 to about 7 cm (e.g., about 3 to about 5 cm) at 15 seconds and 40° F. In some embodiments, a treated fruit having a Bostwick viscosity of about 2 to about 7 cm at 15 seconds and 40° F. can be suitable for inclusion in a fresh dairy product, an ice cream, or a similar product as a mixed-in fruit. In some embodiments, a treated fruit provided herein can have a Bostwick viscosity of about 5 cm or less (e.g., about 1 to about 5 cm) at 15 seconds and 40° F. In some embodiments, a treated fruit having a Bostwick viscosity of about 5 cm or less at 15 seconds and 40° F. can be suitable for inclusion in a fresh dairy product, an ice cream, or a similar product as a fruit-on-top, a fruit-on-the-bottom, or a fruit-on-the-side, or as a jam-like product on its own.

In some embodiments, a treated fruit provided herein can have an improved yield of fruit pieces of a desired size as compared to fruit that has been thermally pasteurized. Yield can be measured using any appropriate equipment and protocol. Yield need not indicate that fruit pieces remain the same size after pasteurization as before pasteurization. For example, yield can be measured as the number of fruit pieces that are retained on a sieve of a desired size (e.g., a 10 mm sieve, a 5 mm sieve, a 2.38 mm sieve, or the like) after pasteurization as a percent of the total number of fruit pieces of any size before pasteurization. In another example, yield can be measured as the number of fruit pieces that are retained on a sieve of a desired size (e.g., e.g., a 10 mm sieve, a 5 mm sieve, a 2.38 mm sieve, or the like) after pasteurization as a percent of the number of fruit pieces retained on the same sieve before pasteurization.

In some embodiments, a treated fruit provided herein can have a flavor that more closely resembles fresh fruit as compared to a thermal pasteurized fruit. As used herein, the term “fresh” refers to a fruit that is whole, cut, washed, or unwashed, but has not otherwise been processed or had any additional treatment (e.g., added chemicals, irradiation, thermal treatment, and the like). A fresh fruit can be at ambient temperature or refrigerated at a temperature above 0° C., unless otherwise indicated herein. Flavor of a treated fruit can be compared to fresh fruit and thermally pasteurized fruit using a trained or untrained tasting panel. Statistical significance is not necessary to determine whether a treated fruit has a flavor more closely resembling fresh fruit. However, tasting panels of 10 trained panelists and standard tasting panel protocols can provide suitable comparison data for determining whether a treated fruit more closely resembles fresh fruit as compared to a thermally pasteurized fruit.

In some embodiments, a treated fruit provided herein can have a texture as measured by firmness that more closely resembles fresh fruit as compared to a thermally pasteurized fruit. Firmness can be measured using any appropriate equipment and protocol. For example, firmness can be measured using a TA.XT plus texture analyzer (Stable Micro Systems, Ltd., Surrey, United Kingdom). Briefly, a load cell (ranging from 5 kg to 50 kg, with the same load cell used for all samples to be compared) is attached to a TA.XT plus texture analyzer. The TA.XT plus texture analyzer is further fitted with a Mini Kramer Shear cell (Stable Micro Systems). A sample to be measured is placed in the sample holder of the Mini Kramer Shear cell in an amount sufficient to fill the chamber of the Mini Kramer Shear cell (e.g., about 14 g of 10 mm² strawberry cubes, or about 10 g whole blueberries). Multiple pieces can be used, or the sample cut as necessary to line the bottom of the sample holder. Texture is measured by applying the “Button” setting with a trigger distance of 29 mm, a test speed of 1 mm/second, with the total duration of a single test being 29 seconds. Data is expressed as a curve of kg force over time in seconds. Firmness is measured as the average area in kg between the curve and a 10 g baseline up to peak force over 3 repetitions. As measured using a TA.XT plus texture analyzer, a treated fruit provided herein can have a firmness that more similar to a fresh fruit of the same type than the same type of fruit treated using thermal pasteurization.

In some embodiments, fruit firmness can be qualitatively measured by biting and/or chewing using trained human subjects. In some embodiments, firmness of a treated fruit provided herein can be similar to an untreated fresh fruit after harvest and prior to significant softening as compared to the same type of fruit treated using a thermal pasteurization process.

### EXAMPLES

### Example 1

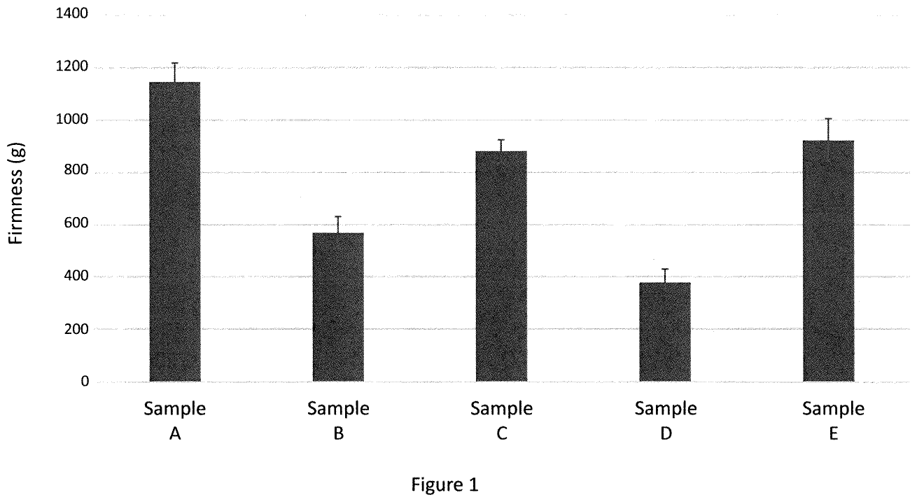

Strawberries were cut into cubes approximately 10 mm on a side before treatment. In FIG. 1, Sample A included untreated fresh strawberry cubes; Sample B included IQF strawberry cubes mixed with sugar, then thawed; Sample C included fresh strawberry cubes subjected to HPP at 86,000 psi for 120 seconds (no tempering, no sugar); Sample D included IQF strawberry cubes mixed with sugar, then subjected to HPP at 86,000 psi for 120 seconds (no tempering); Sample E included IQF strawberry cubes sprayed with a CaCl₂/PME solution at a 1:1 ratio by weight, mixed with sugar, then tempered, then subjected to HPP at 86,000 psi for 120 seconds. Firmness was measured using a TA.XT plus texture analyzer (Stable Micro Systems, Ltd., Surrey, United Kingdom) according to the protocol described above.

As can be seen in FIG. 1, samples treated according to a method provided herein had a firmness most similar to fresh strawberries.

### Example 2

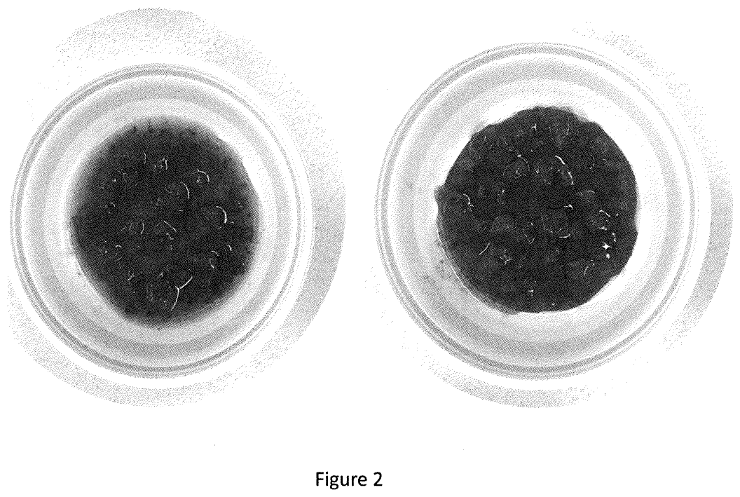

Strawberries were cut into cubes approximately 10 cm on a side and combined with sugar before treatment. A heat pasteurized sample was produced by using either a batch cooker, tube-in-tube heat exchanger, or a contherm heat exchanger to provide sufficient pasteurization of the fruit. Heat pasteurized samples were cooled to a temperature of less than 160° F. before placing into packages for refrigerated storage. The heat pasteurized sample is shown on the left in FIG. 2, and had a yield of 58%. An HPP sample was produced by individually quick freezing the strawberry cubes, spraying the frozen cubes with a CaCl2/PME solution at a 1:1 ratio by weight, mixing the CaCl2/PME-treated frozen cubes with sugar and water, tempering, then subjecting to HPP at 86,000 psi for 120 seconds. The HPP sample is shown on the right in FIG. 2, had a yield of 82%. Yield was measured as the number of pasteurized fruit pieces retained on a 5 mm sieve as a percentage of the total amount of fruit pieces added to the formula prior to pasteurization.

The implementations described above and other implementations are within the scope of the following claims. One skilled in the art will appreciate that the present disclosure can be practiced with embodiments other than those disclosed. The disclosed embodiments are presented for purposes of illustration and not limitation.

1. A method of making a treated fruit, the method comprising:
a. providing a premix in a container at a temperature at or below 70° F., the premix including:
i. about 10% to about 98% fruit by weight,
ii. 0.009% to about 0.05% pectin methylesterase (PME) by weight of the fruit,
iii. 0.009% to about 0.1% calcium salt by weight of the fruit,
iv. about 1% to about 45% sugar by weight, and
v. up to about 88% water by weight;
b. producing tempered fruit by tempering the premix at a temperature of about 110° F. to about 160° F. for 20-60 minutes;
c. adjusting the temperature of the tempered fruit to a temperature of 32-70° F.; and
d. subjecting the cooled tempered fruit to high pressure pasteurization (HPP) to produce the treated fruit.

2. The method of claim 1, further comprising producing the premix by:
a. providing a frozen fruit composition, the frozen fruit composition including individually frozen fruit;
b. mixing the frozen fruit composition with water or an aqueous solution and dry ingredients to produce the premix; and
c. placing the premix in the container.

3. The method of claim 2, wherein the frozen fruit composition comprises PME and/or calcium.

4. The method of claim 2, wherein the aqueous solution comprises PME and/or calcium.

5. The method of claim 2, wherein the dry ingredients comprise PME and/or calcium.

6. The method of claim 2, further comprising producing the frozen fruit composition by:
a. providing individually frozen fruit;
b. applying a solution of PME to the surface of the individually frozen fruit; and
c. a solution including calcium to the surface of the individually frozen fruit.

7. The method of claim 6, wherein the PME and calcium are in a single solution.

8. The method of claim 6, wherein the PME is applied at a rate of about 0.01% to about 0.03% by weight enzyme based on the weight of the individually frozen fruit.

9. The method of claim 6, wherein the calcium is applied at a rate of about 0.01% to about 0.06% calcium salt by weight based on the weight of the individually frozen fruit.

10. The method of claim 1, wherein the premix further includes starch or pectin.

11. The method of claim 1, wherein the premix further includes about 0.05% to about 2% pectin.

12. The method of claim 1, wherein the premix further includes about 1% to about 5% pregelatinized starch.

13. The method of claim 1, wherein the premix is tempered at 130-140° F. for 40-60 minutes.

14. The method of claim 1, wherein HPP is performed at 80,000 psi to about 90,000 psi for 60 seconds to 180 seconds.

15. The method of claim 14, wherein HPP is performed at about 86,000 psi for about 120 seconds.

16. The method of claim 1, wherein the tempered fruit is stored in refrigerated or frozen conditions prior to adjusting the temperature of the tempered fruit to 32-70° F.
